(19) United States
(12) Patent Application Publication
(10) Pub. No.: US 2015/0113185 A1
(43) Pub. Date: Apr. 23, 2015

(54) MULTI-TAG OPERATING SYSTEM AND OPERATING METHOD THEREOF

(71) Applicant: AQ CORPORATION, Suwon-Si, Gyeonggi-Do (KR)

(72) Inventor: Sang Hoon Lee, Suwon (KR)

(21) Appl. No.: 14/364,664

(22) PCT Filed: Dec. 6, 2012
(86) PCT No.: PCT/KR2012/010497

§ 371 Date: Jan. 9, 2015

(30) Foreign Application Priority Data
Dec. 6, 2011 (KR) 10-2011-0129734

(51) Int. Cl. G06F 13/42; H04W 4/00

(52) U.S. Cl. CPC G06F 13/4282; H04W 4/008
USPC 710/106

(57) ABSTRACT

Disclosed are a multi-tag operation system and an multi-tag operation method. The present invention can transmit a format of NDEF data through one tagging operation and thereby can be utilized as an efficient transmission method compared with the transmission of tag data through several tagging operations by providing a multi-tag terminal including: an input/output unit for outputting a plurality of tag data lists and receiving selection commands of tag data to be transmitted; a memory unit for storing the plurality of tag-data lists; a multi-tag operation control unit for securing a plurality of divided data sections in a data section of NDEF data, and recording the tag data selected from the input/output unit in the divided data areas; and an NFC antenna unit for transmitting/receiving the NDEF data to/from the outside.

### TECHNICAL FIELD

The present disclosure relates to a multi-tag operation system and an operation method thereof, and more particularly, to a system and method for generating a NDEF data from a plurality of tag data, and separating the NDEF data into the plurality of tag data to be stored.

### BACKGROUND ART

A mobile terminal is equipment wirelessly connecting and communicating with a desired counterpart while freely moving within a service area formed by a mobile communication system. Utilization of the mobile terminal, which is always carried in preparation for communication that may occur at any time at any place, is low since the time of actually using the mobile terminal is very short. The utilization thereof tends to be enhanced by adding functions of an MP3 player, a camera, a voice recorder, a multimedia player, a game console, a small computer and the like. Recently, the utilization thereof is further enhanced by adding a near field communication (NFC) function for electronic payment, P2P communication, tagging and the like.

Since a mobile terminal recently tends to be provided with a near field communication (NFC) function, the mobile terminal will be described below by defining a mobile terminal as an NFC terminal.

In addition, as the price and communication costs of an NFC terminal are lowered due to advancement of communication technologies, development of manufacturing techniques, improvement of mass-production techniques and the like and the personal communication age has arrived, an adult has come to possess one NFC terminal on average.

Meanwhile, in modern days, various contents in the form of pictures, voices, moving images and the like are provided to people on the street through wall papers, posters, sign boards, street facilities, flyers, radios, movies and TVs, web banners, magazines, newspapers, stickers and the like.

Such various contents can be transmitted and received between NFC terminals through NFC communications.

However, such contents should be generally formed as one tag applet for a content to transmit the various contents to other terminals.

Accordingly, there is cumbersomeness in that a plurality of contents is created into respective tag applets that in turn should be transmitted individually.

Therefore, there is a need for development of a technique for transmitting a plurality of tag applets even through one transmission operation by including a plurality of tag data.

### DISCLOSURE OF EMBODIMENTS OF INVENTION

### Technical Problem

An aspect of the present invention is to provide a system and a method for operations of creating a NDEF tag data by recording a plurality tag data in a data section (area) of the NDEF data.

In addition, another aspect of the present invention is to provide a system and a method for managing multi tag data, wherein a plurality of tag data stored in a single NDEF data is used to create a plurality of NDEF data including respective tag data separated from the plurality of tag data.

Other aspect of the present invention can be easily understood from descriptions of embodiments thereof described below.

### Technical Solution

A multi-tag terminal according to an embodiment of the present invention may include an input/output unit for outputting a list of a plurality tag data and receiving a command to select tag data to be transmitted; a memory unit for storing the plurality of tag data; a multi-tag operation control unit for securing a plurality of partitioned data sections (areas) in a data section (area) of a NDEF data and recording the tag data selected via the input/output unit in the partitioned data sections of the NDEF data; and an NFC antenna unit for transmitting and receiving the NDEF data to and from the outside.

An NFC terminal according to an embodiment of the present invention may include a data storage unit for receiving and storing tag data from the outside the terminal; a multi-tag operation control unit for securing a plurality of partitioned data sections in a data section of NDEF data and for recording the tag data stored in the data storage unit in the partitioned data sections; and a communication unit for transmitting and receiving the tag data to and from the outside.

A server according to an embodiment of the present invention may include a tag data DB unit for storing a plurality of tag data; a tag information DB unit for storing detailed information corresponding to the respective tag data stored in the tag data DB unit; and a multi-tag operation control unit for securing a plurality of partitioned data sections in a data section of NDEF data and recording the tag data stored in the tag data DB unit in the partitioned data sections (areas).

A multi-tag operation system according to an embodiment of the present invention may include a multi-tag terminal for creating multi-tag NDEF data by arranging and storing a plurality of tag data in a data section of NDEF data; an NFC terminal for receiving the multi-tag NDEF data from the multi-tag terminal and separating the (respective) tag data stored in the data section to create independent NDEF data; and a server for storing detailed tag information corresponding to each of the separated (extracted) tag data from the multi-tag NDEF data and providing the NFC terminal with the detailed tag information.

A multi-tag operation system according to an embodiment of the present invention may include a multi-tag terminal for storing a plurality of tag data (a plurality of pieces of tag data); an NFC terminal for selectively receiving and storing a plurality of tag data from the multi-tag terminal and arranging and storing the received tag data (pieces of tag data) in a data section of NDEF data to create multi-tag NDEF data; and a server for storing detailed tag information corresponding to each of the tag data separated from the multi-tag NDEF data and providing the NFC terminal with the detailed tag information.

A multi-tag operation method according to an embodiment of the present invention may include: selecting a plurality of tag data; forming a plurality of spaces for recording the tag data in a data section of NDEF data; and sequentially recording the selected tag data to form multi-tag NDEF data.

A multi-tag operation method according to an embodiment of the present invention may include: selecting a tag data among a plurality of tag data; forming a space for recording the selected tag data in a data section of NDEF data; recording the selected tag data in the data section formed in the NDEF data; selecting another tag data among the plurality of tag data; forming a space for recording the selected other tag data in the data section of the NDEF data; and recording the selected other tag data in the data section formed in the NDEF data to form multi-tag NDEF data.

The multi-tag operation method according to the embodiment of the present invention may further include: separating a plurality of tag data from the multi-tag NDEF data; and recording the plurality of separated tag data in data spaces (sections) of a new plurality of NDEF data, respectively, to create the new plurality NDEF tag data.

The multi-tag operation method according to the embodiment of the present invention may further include: separating a plurality of tag data from the multi-tag NDEF data; mapping tag information corresponding to each of the plurality of separated tag data and receiving the corresponding tag information; and recording the plurality of separated tag data and the tag information received through the mapping in data spaces of a plurality of NDEF data, respectively, to create a plurality of NDEF tag data.

In the multi-tag operation method according to the embodiment of the present invention, selecting the plurality of tag data may further include finding the number of tag data to be selected, and sequentially recording the the plurality of tag data selected to generate multi-tag NDEF data is characterized in that the multi-tag NDEF data is created by recording the number of tag data in a counter section (space) of the data section formed in the NDEF data and sequentially recording the plurality of tag data selected.

A multi-tag operation method according to an embodiment of the present invention may include: selecting one tag data among a plurality of tag data; transmitting the selected tag data to an NFC terminal; selecting another tag data among the plurality of tag data; transmitting the selected other tag data to the NFC terminal; forming a space for recording the selected and transmitted tag data in a data section of NDEF data; and recording the plurality of transmitted tag data in the data section formed in the NDEF data to form multi-tag NDEF data.

The multi-tag operation method according to the embodiment of the present invention may further include: selecting and separating a tag data to be used from the multi-tag NDEF data; and creating NDEF tag data including the separated tag data.

The multi-tag operation method according to the embodiment of the present invention may further include: selecting and separating tag data to be used from the multi-tag NDEF data; mapping tag information corresponding to each of the plurality of separated tag data and receiving the corresponding tag information; and recording the plurality of separated tag data and the tag information received through the mapping in data spaces of a plurality of NDEF data, respectively, to create a plurality of NDEF tag data.

### ADVANTAGEOUS EFFECT

Since the present invention can transmit a plurality of tag data in the format of NDEF data through one tagging operation, there is an advantage in that a more efficient transmission scheme can be utilized as compared with a scheme of transmitting tag data through several tagging operations.

Since the present invention may separate a plurality of tag data from a multi-tag NDEF data and create and use respective NDEF tag data including the corresponding tag data, there is an advantage in that efficient storage is enabled using relatively small size data.

### BRIEF DESCRIPTION OF DRAWINGS

FIG. 1 illustrates detailed configurations of a multi-tag terminal and a server according to an embodiment of the present invention.

FIG. 2 illustrates configuration of a multi-tag operation system including the detailed configuration of an NFC terminal according to an embodiment of the present invention.

FIG. 3 is a flowchart illustrating a multi-tag operation method according to an embodiment of the present invention.

FIG. 4 is a flowchart illustrating a process of creating a multi-tag NDEF data according to an embodiment of the present invention.

FIG. 5 is a flowchart illustrating a process of creating multi-tag NDEF data according to an embodiment of the present invention.

FIG. 6 is a flowchart illustrating a multi-tag operation method according to an embodiment of the present invention.

FIG. 7 is illustrates a structure of multi-tag NDEF data according to an embodiment of the present invention.

### BEST MODE FOR CARRYING OUT THE INVENTION

Although various changes and numerous embodiments may be made in the present invention, particular embodiments will be illustrated in the accompanying drawings and set forth in detail in the following description. However, this is not intended to limit the present invention to the particular embodiments, and it should be appreciated that all changes, equivalents, and substitutes falling within the spirit and scope of the present invention are encompassed in the present invention. If it is considered that upon explanation of the present invention, a detailed description of a related known technique may obscure the subject matter of the present invention, the detailed description thereof will be omitted.

Hereinafter, embodiments of a multi-tag operation system and an operation method thereof according to the present invention will be described in detail with reference to the accompanying drawings. Upon description of the present invention with reference to the accompanying drawings, like or corresponding components are designated by like reference numerals and repeated descriptions thereof will be omitted.

Since NFC is a scheme for wireless communication in a short distance of 10 cm, it is operated, using its characteristics of low power consumption, in a card mode of making an electronic payment in a financial transaction such as a credit card transaction, a P2P mode of establishing a one-to-one wireless connection and transmitting and receiving data signals, a reader mode of reading and confirming simple information, and the like.

Tagging may be described as a series of actions that transitioning from a separated status (position) and to a touch (approached) status and then transitioning from the touch status and to a separated status.

A wireless mobile communication network means a communication network for wirelessly connecting and communicating with a desired counterpart at any time at any place while freely moving within a service area formed by the communication network, and includes commercialized wireless mobile communication networks such as an analog communication network and the second, third and fourth generation communication networks, and all other uncommercialized communication schemes.

An active tag means a tag that is powered by an embedded battery, and a passive tag refers to a tag that is operated without a separate battery but using a DC voltage converted from RF power transmitted from a reader.

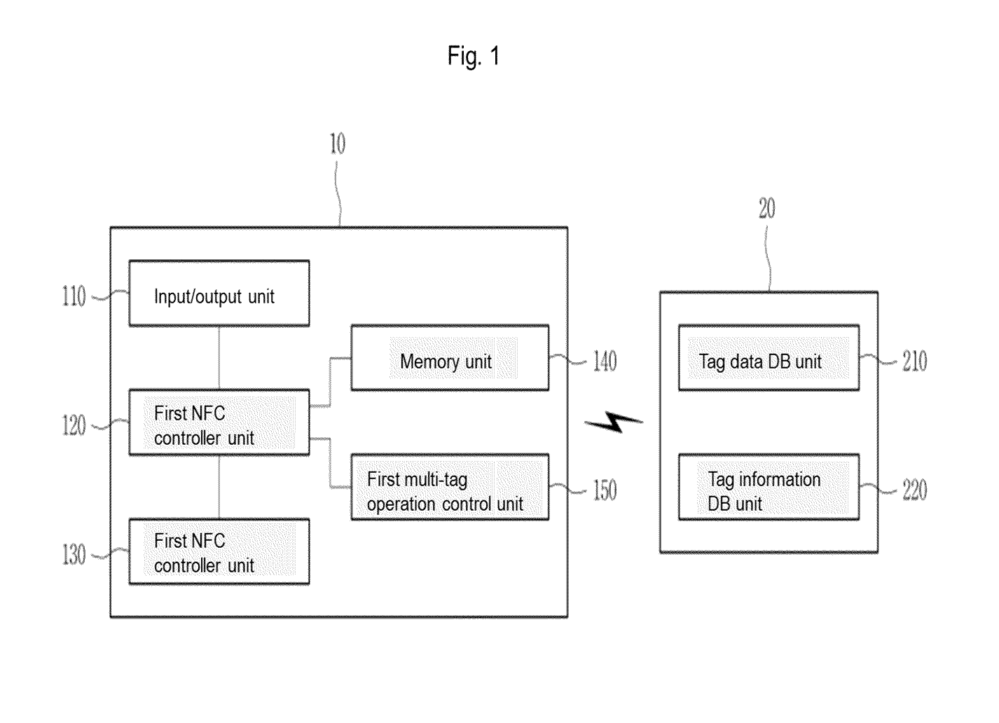

FIG. 1 is a view showing the detailed configurations of a multi-tag terminal 10 and a server 20 according to an embodiment of the present invention.

A multi-tag operation system according to an embodiment of the present invention includes the multi-tag terminal 10, the server 20 and an NFC terminal (not shown).

The multi-tag terminal 10 may create a multi-tag NDEF data by arranging and storing a plurality of tag data in data sections (areas) of the NDEF data.

The NFC terminal (not shown) may receive the multi-tag NDEF data from the multi-tag terminal 10, separate the tag data stored in the data area, and create independent NDEF data including each of the separated tag data.

The server 20 may store detailed tag information corresponding to each of tag data is separated from the multi-tag NDEF data and provide the NFC terminal with the detailed tag information.

The multi-tag terminal 10 includes an input/output unit 110, a first NFC controller unit 120, an NFC antenna unit 130, a memory unit 140 and a first multi-tag operation control unit 150.

The input/output unit 110 may output a list of a plurality of tag data and receive a command to select a tag data to be transmitted.

The input/output unit 110 is preferably configured with a touch panel, outputs the list of tag data on the touch panel so that a user may select a desired tag data, and allows the user to select a tag data intended to be transmitted by touching the touch panel with a hand.

The input/output unit 110 does not necessarily need to be configured as a single device, and the input/output unit 110 may be configured with separate input and output devices as appreciated by those skilled in the art.

The first NFC controller unit 120 may control each of units incorporated into the multi-tag terminal 10.

The first NFC controller unit 120 may convert a data format transmitted and received through the NFC antenna unit 130 into a format that can be transmitted and received in an NFC communication scheme or convert received information into a format that can be utilized in the multi-tag terminal.

The NFC antenna unit 130 may transmit and receive data to and from the outside. To this end, the NFC antenna unit 130 may include a communication module including an antenna for communication.

The memory unit 140 may store a plurality of tag data (a plurality pieces of tag data.

The tag data refers to data containing information correspondinOg to contents desired by a user.

For example, in case of a ticket needed to enter a theater, unique information on the corresponding ticket, such as showtime, the type of a performance, a seat number and a performance poster, may be included in the tag data.

Further, the tag data may contain information on a discount coupon that can be used at a corresponding affiliated store, such as the type of a coupon, the location of the affiliated store, an expiry date, and benefits and a picture of the coupon.

The first multi-tag operation control unit 150 may secure a plurality of partitioned data sections in a data section of NDEF data and then record tag data, which has been selected through the input/output unit 110, in the partitioned data areas.

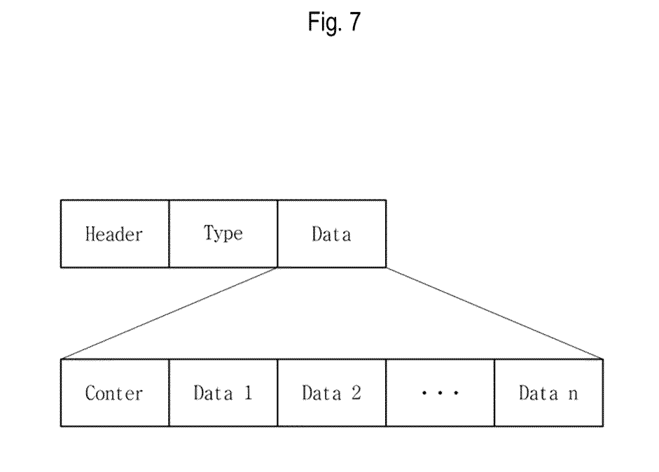

The internal data structure of the NDEF data will be described with reference to FIG. 7.

FIG. 7 is a view showing the structure of the space of multi-tag NDEF data according to an embodiment of the present invention.

Multi-tag NDEF data refers to NDEF data having a plurality of tag data recorded in the data section of the NDEF data.

The structure of the NDEF data may be comprised of a header, a type and a data area.

Since the header and the type are apparent to those skilled in the art, descriptions thereof will be omitted.

The data section of the NDEF data generally has a tag data recorded therein, and the corresponding tag data allows the type of the corresponding NDEF data to be identified.

In the structure of NDEF data according to an embodiment of the present invention, the data section is formed with a plurality of partitioned spaces including a counter section and data spaces sequentially arranged, wherein the counter section corresponding to a first one of the spaces has the number of included tag data recorded in the counter area, and data spaces with respective tag data recorded therein.

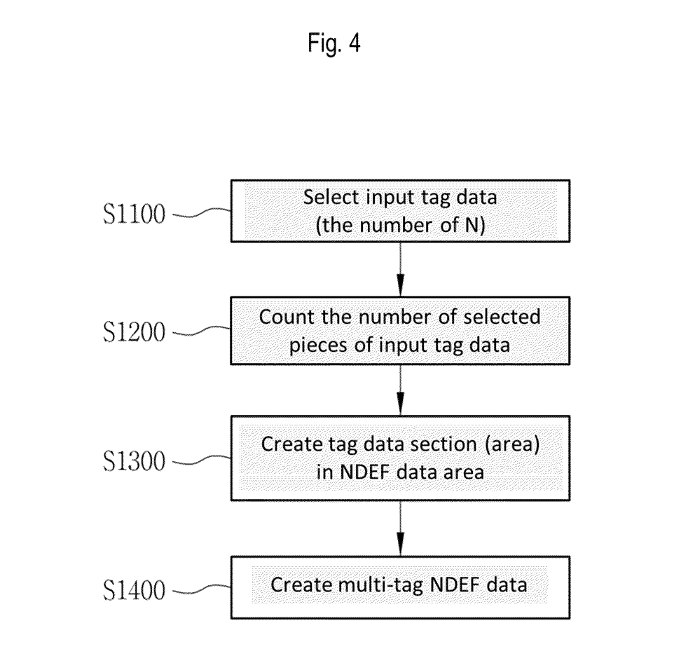

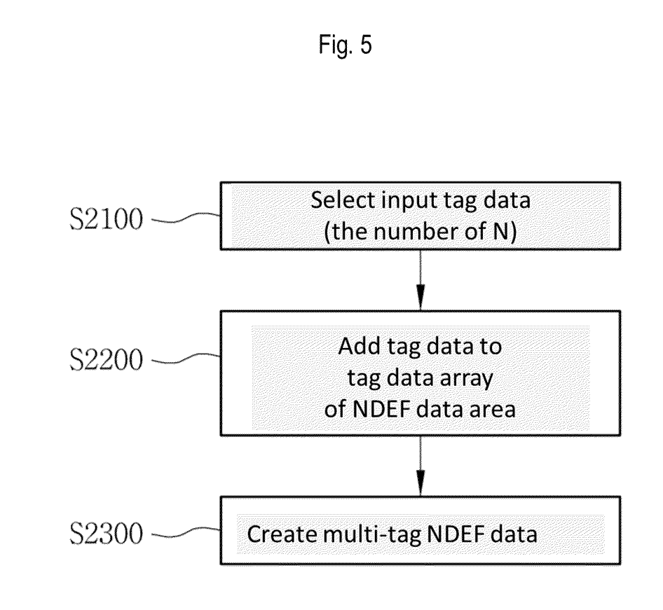

A process of recording a plurality of tag data in the data section in the course of creating multi-tag NDEF data will be described below with reference to FIGS. 4 and 5.

The server 20 includes a tag data DB unit 210 and a tag information DB unit 220.

The tag data DB unit 210 may store a plurality of tag data therein.

The tag data DB unit 210 may transmit a plurality of tag data wiredly or wirelessly according to a request by the multi-tag terminal 10.

The tag information DB unit 220 may store detailed information corresponding to the tag data stored in the tag data DB unit 210.

The tag data has been described above, and the detailed information corresponding to the tag data may be stored as information on the type of contents such as a ticket, a coupon, a credit card, a membership card, a still image, a moving image and the like.

The detailed information may include an issuance date of tag data, and in case of tag data on a coupon or a ticket of which a used state is important, include information on a use history of the coupon or ticket, and the like.

Similarly to the multi-tag terminal 10 which creates multi-tag NDEF data through the first multi-tag operation control unit 150, the server 20 may include a separate multi-tag operation control unit (not shown), and multi-tag NDEF data may be created and transmitted on the server 20 according to a request by a user.

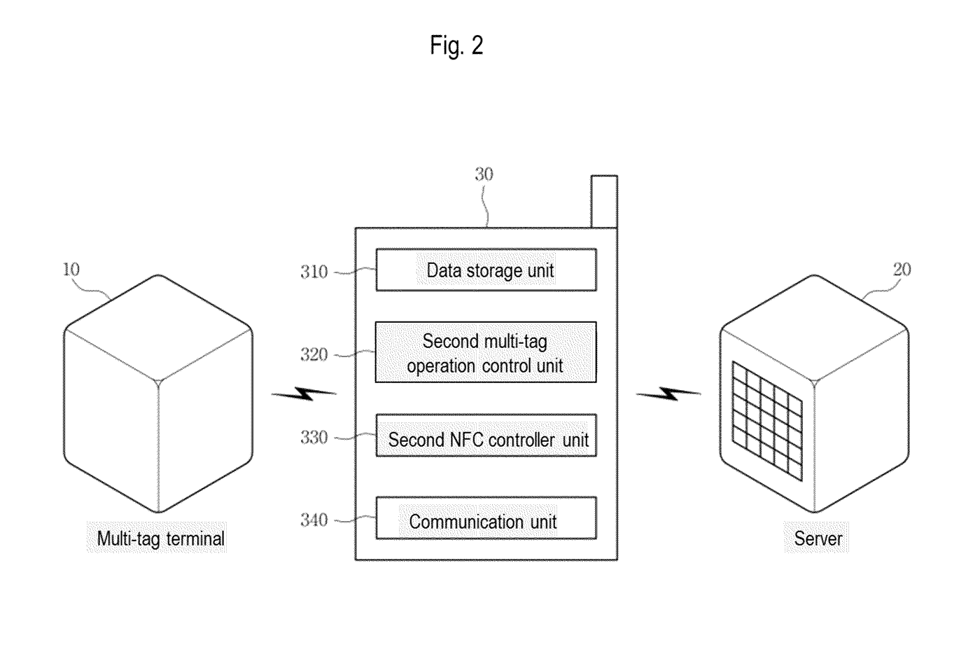

FIG. 2 is a view showing the configuration of a multi-tag operation system including the detailed configuration of an NFC terminal according to an embodiment of the present invention.

A multi-tag operation system according to an embodiment of the present invention includes a multi-tag terminal 10, a server 20 and an NFC terminal 30.

The multi-tag terminal 10 may store a plurality of tag data.

The NFC terminal 30 may selectively receive and store a plurality of tag data from the multi-tag terminal 10 and create multi-tag NDEF data by arranging and storing the received tag data in the data section (area) of the NDEF data.

The server 20 may store detailed tag information corresponding to each of tag data separated from the multi-tag NDEF data and provide the NFC terminal with the detailed tag information.

Since the detailed configurations of the multi-tag terminal 10 and the server 20 are the same as those illustrated in FIG. 1, descriptions thereof will be omitted.

The NFC terminal 30 includes a data storage unit 310, a second multi-tag operation control unit 320, a second NFC controller unit 330, and a communication unit 340.

The data storage unit 310 may receive and store a plurality of tag data from the multi-tag terminal 10.

Since the detailed description of the tag data has been made in connection with FIG. 1, a description thereof will be omitted.

The second multi-tag operation control unit 320 may secure a plurality of partitioned data sections in a data section of NDEF data, and record the tag data, which has been stored in the data storage unit 310, in the partitioned data areas.

Since the partitioned data section of the NDEF data has been described in connection with FIG. 1, a description thereof will be omitted.

The second NFC controller unit 330 may control each of constitutional units belonging to the NFC terminal 30.

The second NFC controller unit 330 may convert a data format transmitted and received through the NFC antenna unit 340 into a format that can be transmitted and received in an NFC communication scheme or convert received information into a format that can be utilized in the NFC terminal 30.

The communication unit 340 may transmit and receive data to and from the outside.

To this end, the communication unit 340 may include a communication module including an antenna for communication. Accordingly, the NFC terminal 30 may transmit and receive data to and from the multi-tag terminal 10 or the server 20 through an NFC communication scheme or a mobile communication network.

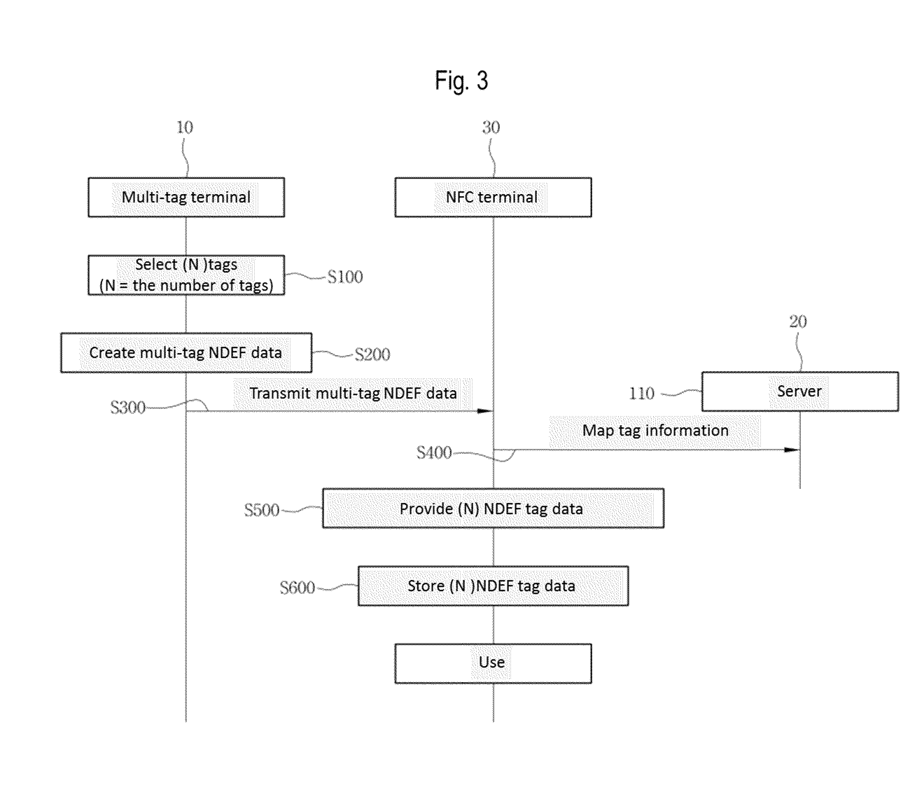

FIG. 3 is a flowchart illustrating a multi-tag operation method according to an embodiment of the present invention.

Preferably, the multi-tag operation method corresponds to an operation method utilizing an active tag.

Step S100 is a step of selecting a plurality of tag data by the multi-tag terminal 10.

A user may select tag data intended to be transmitted from a list of tag data.

Step S200 is a step of creating multi-tag NDEF data.

The process of creating the multi-tag NDEF data will be described below through FIGS. 4 and 5.

Step S300 is a step of tagging the NFC terminal 30 to the multi-tag terminal 10 so as to transmit the multi-tag NDEF data.

Step S400 is a step of mapping tag information on a plurality of tag data included in the multi-tag NDEF data from the NFC terminal 30 to the server 20.

The process of mapping tag information is a process of searching for a plurality of tag data stored in the server 20 and tag information corresponding to each of the tag data.

The tag data contains unique information on a coupon or a ticket, for configuring independent NDEF tag data. The corresponding unique information can configure independent NDEF tag data including respective separated tag data after receiving location information or picture information, which are classified as high volume information according to an operation scheme by a user, from the data space mapped in the server 20.

As another embodiment, the tag data may include connection information such a uniform resource locator (URL) allowing for establishing a link to receive necessary information by connecting information on a separate coupon or ticket for configuring independent NDEF data to a unique data area (section). Accordingly, a plurality of tag data recorded in the multi-tag NDEF data section includes connection information used for receiving detailed information corresponding to each of tag data from the server. When the plurality of tag data is classified (mapped) into a plurality of NDEF tag data, detailed information on corresponding tag data may be received from the server and configured into independent NDEF tag data.

Step S400 is a step which exists when separate data mapped to tag data is needed and may be omitted if unique information is recorded in each of tag data and separate data is not required to reconfigure the tag data into independent respective NDEF tag data.

Step S500 is a step of creating a plurality of independent NDEF tag data by classifying and storing each of the tag data searched through the tag information mapping process identified between the server 20 and the NFC terminal 30 at step S400 into the data space of the NDEF tag data. If there is no separate mapping process in step S400, the data transferred through the mapping process is not utilized separately, and each of the tag data separated from the multi-tag NDEF data section is reconfigured into independent NDEF tag data.

Step S600 is a step of storing a plurality of NDEF tag data, which has been created for the plurality of respective tag data created at step S500, in separate storage spaces.

FIG. 4 is a flowchart illustrating a process of creating a multi-tag NDEF data according to an embodiment of the present invention.

Since step S1100 is a process identical to step S100 of FIG. 3, a detailed description thereof will be omitted.

Step S1200 is a step of finding the number of tag data selected at step S1100.

For example, if a user selects four tag data out of ten tag data, the number of tag data can be recognized in the form of 4 or 4/10.

Step S1300 is a step of forming spaces for recording a plurality of tag data selected at step S 1100 in a data section provided in NDEF data.

If four tag data are found at step S1200, four or five separated spaces are configured, and information on the number of tag data found at step S1200 is recorded in a first space, and the respective tag data can be recorded in the other four spaces. Alternatively, the respective tag data may be recorded in the four spaces starting from a first space.

Step S1400 is a process of completing creation of the multi-tag NDEF data by recording all the data through step S1300. After completing this process, a plurality of tag data is stored in multi-tag NDEF data, so that the plurality of tag data can be transferred to another device in the form of NDEF data through one tagging operation.

FIG. 5 is a flowchart illustrating a process of creating multi-tag NDEF data according to an embodiment of the present invention.

Step S2100 is a step of selecting a tag data among a plurality of tag data. Although several tag data can be selected at a time at step S1100, step S2100 is a process of selecting only one data at a time.

Step S2200 is a step of providing a space for arranging tag data in a data section of NDEF data in order to record the tag data selected at step S2100 and recording the tag data selected at step S2100 in the space.

When step S2200 is completed, the flow returns to step S2100 in order to add another tag data and a new tag data is selected, a new space is provided in the data section of the NDEF data in order to record the newly selected tag data, and the selected another tag data in the new space.

Since step S2300 is the same as S1400 of FIG. 4, a detailed description thereof will be omitted.

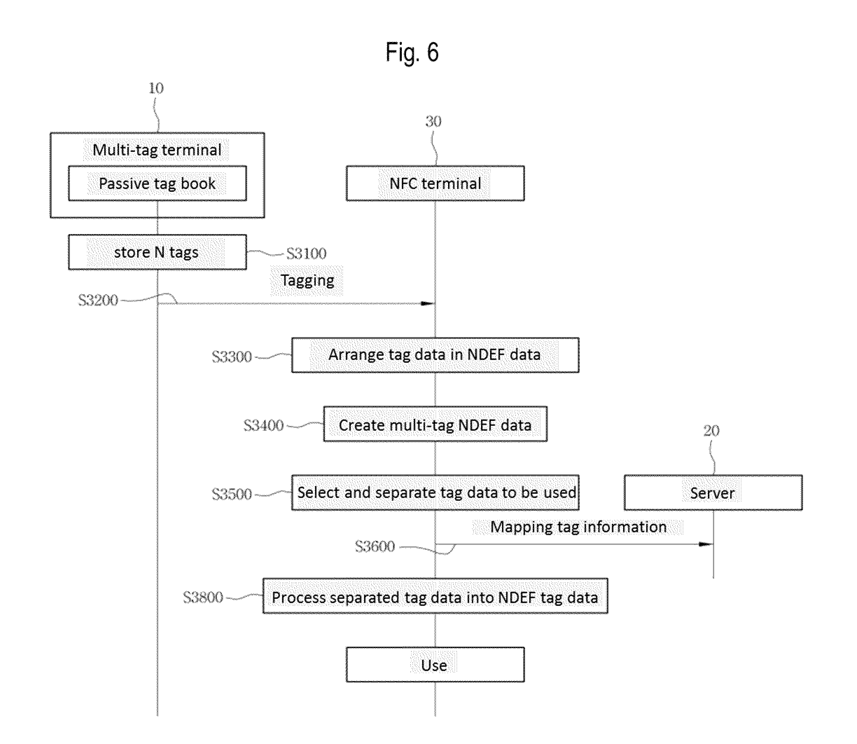

FIG. 6 is a flowchart illustrating a multi-tag operation method according to an embodiment of the present invention.

Preferably, the multi-tag operation method corresponds to an operation method utilizing a passive tag.

Step S3100 is a step of storing a plurality of tag data in a tag book included in the multi-tag terminal 10 and selecting one tag data among the plurality of tag data.

Step S3200 is a step of tagging the NFC terminal 30 to the multi-tag terminal 10 and transmitting the selected tag data.

If a user desires a plurality of tag data, the plurality of tag data can be transmitted to the NFC terminal 30 by repeatedly performing steps S3100 and S3200.

Step S3300 is a step of forming a space for recording the selected and transmitted tag data in the data section of the NDEF data and arranging the tag data.

Step S3300 is different in that the process is performed in the NFC terminal 30. Since the process of recoding the tag data in the data section of the NDEF data is the same as S1300 described above in connection with FIG. 4, a detailed description thereof will be omitted.

Step S3400 is different in that the process is performed in the NFC terminal 30. Since the process of recoding the tag data in the data section of the NDEF data is the same as S1400 described above in connection with FIG. 4, a detailed description thereof will be omitted.

Step S3500 is a step of selecting a tag data to be used among a plurality of tag data stored in the multi-tag NDEF data and separating the corresponding tag data from the multi-tag NDEF data.

Since step S3600 is the same as S400 described above in connection with FIG. 3, a detailed description thereof will be omitted.

Since step S3700 is the same as S500 described above in connection with FIG. 3, a detailed description thereof will be omitted.

Although the present invention has been described in connection with the embodiments thereof, it will be readily understood by those skilled in the art that various modifications and changes can be made thereto without departing from the spirit and scope of the present invention defined by the appended claims.

### INDUSTRIAL APPLICABILITY

By converting a plurality of tag data into a single NDEF data, and by separating and storing the a plurality of tag data, there would be an advantage in that a transmission scheme more efficient than that of transmitting tag data with multiple tagging can be implemented.

1. A multi-tag terminal comprising:
an input/output unit for outputting a list of a plurality of tag data and receiving a command to select tag data to be transmitted;
a memory unit for storing the plurality of tag data;
a multi-tag operation control unit for securing a plurality of partitioned data sections in a data section of NDEF data and recording the tag data selected through the input/output unit in the partitioned data areas; and
an NFC antenna unit for transmitting and receiving the NDEF data to and from the outside.

2. (canceled)

3. (canceled)

4. (canceled)

5. (canceled)

6. A multi-tag operation method comprising:
selecting a plurality of tag data;
forming a plurality of spaces for recording the tag data in a data section of NDEF data; and
sequentially recording the selected tag data to form multi-tag NDEF data.

7. (canceled)

8. The method as claimed in claim 6, further comprising:
separating a plurality of tag data from the multi-tag NDEF data; and
recording the plurality of separated tag data in data spaces of a plurality of NDEF data, respectively, to create a plurality of NDEF tag data.

9. The method as claimed in claim 6, further comprising:
separating a plurality of tag data from the multi-tag NDEF data;
mapping tag information corresponding to each of the plurality of separated tag data and receiving the corresponding tag information; and
recording the plurality of separated tag data and the tag information received through the mapping in data spaces of a plurality of NDEF data, respectively, to create a plurality of NDEF tag data.

10. The method as claimed in claim 6, wherein selecting the plurality of tag data further comprises finding the number of selected tag data, and sequentially recording the selected tag data to form multi-tag NDEF data is characterized in that the multi-tag NDEF data is created by recording the number of tag data in a counter section of the data section formed in the NDEF data and sequentially recording the selected tag data.

11. A multi-tag operation method comprising:
selecting one tag data among a plurality of tag data;
transmitting the selected tag data to an NFC terminal;
selecting another tag data among the plurality of tag data;
transmitting the selected other tag data to the NFC terminal;
forming a space for recording the selected and transmitted tag data in a data section of NDEF data; and
recording the plurality of transmitted tag data in the data section formed in the NDEF data to form multi-tag NDEF data.

12. The method as claimed in claim 11, further comprising:
selecting and separating a tag data to be used from the multi-tag NDEF data; and
creating NDEF tag data including the separated tag data.

13. The method as claimed in claim 11, further comprising:
selecting and separating tag data to be used from the multi-tag NDEF data;
mapping tag information corresponding to each of the plurality of separated tag data and receiving the corresponding tag information; and
recording the plurality of separated tag data and the tag information received through the mapping in data spaces of a plurality of NDEF data, respectively, to create a plurality of NDEF tag data.
